(19) United States
(12) Patent Application Publication
(10) Pub. No.: US 2024/0311209 A1
(43) Pub. Date: Sep. 19, 2024

(54) CONTROLLING MONITORING ROLES OF NODES USING ARTIFICIAL INTELLIGENCE TECHNIQUES

(71) Applicant: Dell Products L.P., Round Rock, TX (US)

(72) Inventors: Pratheek Veluswamy, Bangalore (IN); Shibi Panikkar, Bangalore (IN)

(21) Appl. No.: 18/121,382

(22) Filed: Mar. 14, 2023

(51) Int. Cl. G06F 9/50; G06N 5/022

(52) U.S. Cl. CPC G06F 9/5083; G06N 5/022

(57) ABSTRACT

Methods, apparatus, and processor-readable storage media for controlling monitoring roles of nodes are provided herein. An example computer-implemented method includes obtaining time-series data related to transactions of system nodes in a distributed system, where the distributed system includes monitoring nodes, and a respective one of the monitoring nodes has a primary monitoring role responsible for monitoring operation of the system nodes; classifying, using a first artificial intelligence-based process, load distributions of the transactions across the system nodes based on the time-series data; determining, using a second artificial intelligence-based process, a respective one of the monitoring nodes to be used as the primary monitoring role for at least a 10 portion of one or more time intervals based on a result of the classifying; and controlling transitions of the primary monitoring role between the monitoring nodes for the one or more time intervals based on a result of the determining.

### FIELD

The field relates generally to information processing, and more particularly to monitoring of information processing systems.

### BACKGROUND

Information technology infrastructure may include distributed systems in which information technology elements are deployed at various computing sites. Such distributed systems include distributed database systems, in which the information technology elements comprise databases or database nodes of a distributed database which are deployed in two or more different data centers or other computing sites.

### SUMMARY

Illustrative embodiments of the disclosure provide techniques for controlling monitoring roles of nodes using artificial intelligence (AI) techniques. An exemplary computer-implemented method includes: obtaining time-series data related to transactions of a plurality of system nodes in a distributed system, wherein the distributed system comprises a plurality of monitoring nodes, wherein a respective one of the plurality of monitoring nodes has a primary monitoring role responsible for monitoring operation of the plurality of system nodes; classifying, using at least one first artificial intelligence-based process, load distributions of the transactions across the plurality of system nodes based at least in part on the time-series data; determining, using at least one second artificial intelligence-based process, a respective one of the plurality of monitoring nodes to be used as the primary monitoring role for at least a portion of one or more time intervals based at least in part on one or more results of the classifying; and controlling transitions of the primary monitoring role between the plurality of monitoring nodes for the one or more time intervals based at least in part on one or more results of the determining.

Illustrative embodiments can provide significant advantages relative to conventional monitoring techniques for distributed systems. For example, technical problems associated with monitoring such systems are mitigated in one or more embodiments by implementing AI-based techniques that allow monitoring roles of distributed database clusters to be proactively changed based on varying traffic loads across different regions when monitoring transactions.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for controlling monitoring roles of nodes using AI techniques in an illustrative embodiment.

FIG. 2 shows a monitoring system comprising monitors deployed at two data centers hosting a distributed database system in an illustrative embodiment.

FIG. 3 shows a monitoring system for a distributed database in an illustrative embodiment.

FIG. 4 shows latency between a primary monitor and multiple database nodes in different regions having different transactional load peak times in an illustrative embodiment.

FIG. 5 shows an implementation of topology-aware monitoring role selection of a monitoring system in an illustrative embodiment.

FIG. 6 shows a plot illustrating a clustering of load in different regions at different times in an illustrative embodiment.

FIG. 7 shows a monitoring of latency between a set of monitors and database nodes of a distributed database system in an illustrative embodiment.

FIG. 8 shows a process flow for dynamically controlling monitoring roles in an illustrative embodiment.

FIG. 9 shows an example of a table showing time-based monitor ranks and predictions in an illustrative embodiment.

FIG. 10 shows a flow diagram of a process for controlling monitoring roles of nodes using AI techniques in an illustrative embodiment.

FIGS. 11 and 12 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

With the continued growth of data, distributed databases are becoming important tools for storing data. A distributed database generally refers to a database set (e.g., of multiple database nodes implementing database instances) that can be stored on multiple computers, but appears to applications as a single database. In a distributed database system, an application can access and modify data simultaneously in several databases in a network. When one of the databases (e.g., database nodes or database set, also referred to as a cluster) in a distributed database is down, other databases can take over.

As the importance of distributed databases continues to increase, the monitoring of such distributed databases also increases in importance. Database administrators (DBAs) often need to view and monitor multiple different clusters or database nodes of the distributed database. Distributed database systems generally have one monitoring system that is active at any given time. The database topology for such systems usually includes either one write cluster and multiple read clusters (as is the case for Cassandra® and YugaByte®, for example), or multiple write clusters and multiple read clusters (as is the case for Mongo DB). The data across the clusters are synchronized based on the CAP (consistency, availability, partition tolerance) implementation in each database. If there are multiple “active” monitors, then a race condition can occur (e.g., when two or more operations are attempted to be performed at the same time, but the operations must be done in a particular sequence to be done correctly).

Generally, distributed database systems implement two monitors regardless of the number of clusters in the distributed database. If one monitor fails, the other monitor will take over. Some systems can have more than two monitors, where one or more optimal back up monitors are selected when the primary monitor goes down. The database clusters in such systems can be located in different regions (e.g., different parts of the world). This can cause latency and performance issues associated with monitoring the database as a primary monitor (or active monitor) can be in a cluster located in a first region, and another cluster located in a second region can be experiencing high loads (e.g., related to read and/or write requests).

One or more embodiments described herein can improve the monitoring performance using an AI-based approach that dynamically shifts primary (active) monitors to high load regions throughout a given time period (e.g., a day) for a database having geographically distributed clusters. It is noted that this is different than algorithms used for load balancing, which are not suitable for monitoring transactions in such databases. Such embodiments can be considered a reactive approach that is based on the load balancing and/or load distribution. Accordingly, the active monitor can shift to a particular (e.g., optimal) location, such as a region experiencing a relatively higher load or a region where transactions have a higher priority, thereby reducing the delay in monitoring large loads in the distributed database. Although some techniques are described herein with reference to distributed database systems, it is to be appreciated that such techniques are also applicable to other distributed architectures that implement monitoring roles (e.g., monitoring of distributed applications).

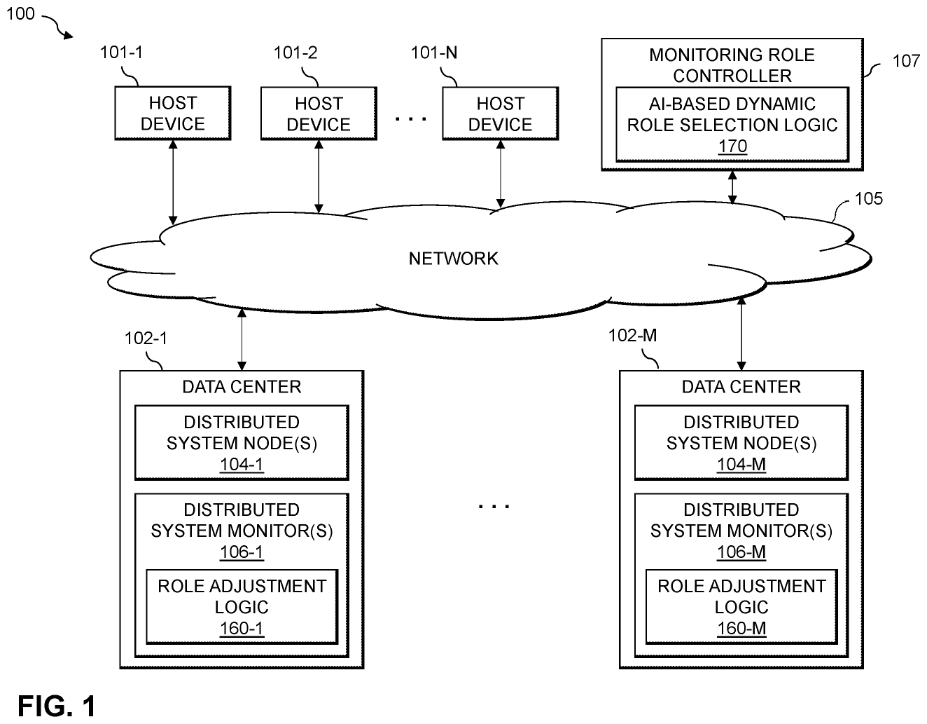

FIG. 1 shows an information processing system 100 configured in accordance with an illustrative embodiment for controlling monitoring roles of nodes using AI techniques. The information processing system 100 comprises one or more host devices 101-1, 101-2, . . . 101-N (collectively, host devices 101) which communicate with one or more data centers 102-1, . . . 102-M (collectively, data centers 102) over a network 105. The data centers 102 each comprise one or more distributed system nodes 104-1, . . . 104-M (collectively, distributed system nodes 104) of a distributed system. The distributed system may comprise, for example, a distributed database system with the distributed system nodes 104 comprising database nodes or instances in the distributed database system. The distributed system may additionally or alternatively describe a distributed computing system, a distributed storage system (e.g., a storage cluster), etc.

More generally, the distributed system nodes 104 comprise information technology (IT) components of an IT infrastructure that are distributed across multiple locations (e.g., the different data centers 102). Such IT components may include physical and/or virtual computing resources. Physical computing resources may include physical hardware such as servers, storage systems, networking equipment, Internet of Things (IOT) devices, satellite devices, other types of processing and computing devices, etc. Virtual computing resources may include virtual machines (VMs), software containers (also referred to herein as containers), etc.

The host devices 101 are assumed to access or otherwise utilize the distributed system (e.g., by submitting transactions or processing requests that will be executed on or utilize one or more of the distributed system nodes 104). The host devices 101 and the data centers 102 may be geographically distributed, such that there is different latency therebetween and also potentially different peak load times for different ones of the distributed system nodes 104 of the distributed system (e.g., at certain times of the day, some of the distributed system nodes 104 may be more active than others).

The host devices 101 and data centers 102 illustratively comprise respective computers, servers or other types of processing devices capable of communicating with one another via the network 105. At least a subset of the host devices 101 and the data centers 102 may be implemented as respective virtual machines of a compute services platform or other type of processing platform. The host devices 101 and the data centers 102 in such an arrangement illustratively provide compute services such as execution of one or more applications on behalf of each of one or more users associated with respective ones of the host devices 101.

The term “user” herein is intended to be broadly construed so as to encompass numerous arrangements of human, hardware, software, or firmware entities, as well as combinations of such entities.

Compute and/or storage services may be provided for users under a Platform-as-a-Service (PaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise.

The data centers 102 in the FIG. 1 embodiment also each comprise one or more distributed system monitors 106-1, . . . 106-M (collectively, distributed system monitors 106, which are examples of monitoring nodes of a monitoring system) implementing role adjustment logic 160-1, . . . 160-M (collectively, role adjustment logic 160). The distributed system monitors 106 1, . collectively provide a monitoring system that monitors operation of the distributed system (e.g., the distributed system nodes 104). Generally, the monitoring system includes one of the distributed system monitors 106 that acts in a “primary” monitoring role for the distributed system, while other ones of the distributed system monitors 106 act in a secondary or backup monitoring role for the distributed system. It should be appreciated, however, that in some cases a monitoring system may include two or more distributed system monitors that act in the primary monitoring role. In various embodiments described below, it is assumed that the monitoring system has only a single distributed system monitor acting in the primary monitoring role and multiple other distributed system monitors acting in the secondary or backup monitoring role. Also, it should be appreciated that the terms “system node” and “monitoring node” are intended to be broadly construed so as to encompass, for example, a given node being both a system node and a monitoring node.

In some embodiments, the primary one of the distributed system monitors 106 sends heartbeat messages at regular intervals to the secondary or backup ones of the distributed system monitors 106. In the event that the secondary or backup ones of the distributed system monitors 106 fail to receive a designated number of heartbeat messages from the primary one of the distributed system monitors 106, one of such secondary or backup ones of the distributed system monitors will take over the primary monitoring role. As will be described in further detail below, the role adjustment logic 160 provides for intelligent selection of which of the second or backup ones of the distributed system monitors 106 will take over the primary role in such situations. Further, the role adjustment logic 160 can enable intelligent movement of the primary role among the distributed system monitors 106 in accordance with time-based rankings (e.g., to reduce latency between the primary one of the distributed system monitors 106 and ones of the distributed system nodes 104 currently experiencing high load conditions).

While in the FIG. 1 embodiment each data center 102 includes both one or more distributed system nodes 104 and one or more distributed system monitors 106, this is not a requirement. In other embodiments, one or more of the data centers 102 may comprise only distributed system nodes or only distributed system monitor instances. Further, the particular number of distributed system nodes and distributed system monitor instances may vary from data center to data center. For example, there may be a first number of distributed system nodes 104-1 in the data center 102-1 and a second, different number of distributed system nodes 104-M in the data center 102-M. Similarly, there may be a third number of distributed system monitor instances 106-1 in the data center 102-1 and fourth, different number of distributed system monitor instances 106-M in the data center 102-M.

Also coupled to the network 105 is a monitoring role controller 107, which implements AI-based dynamic role selection logic 170. The AI-based dynamic role selection logic 170 is configured to utilize one or more AI processes that learn to proactively shift the primary monitoring role based on historical time-based load information collected from different regions of the data centers 102 and/or the distributed system nodes 104, as explained in more detail elsewhere herein.

Although shown as external to the host devices 101 and data centers 102 in the FIG. 1 embodiment, it should be appreciated that the monitoring role controller 107 may be implemented at least partially internal to one or more of the host devices 101 and/or one or more of the data centers 102, including on one or more of the distributed system monitors 106 thereof.

The role adjustment logic 160 is configured to adjust the roles (e.g., between a primary role and a secondary role), for example, based on the output of the AI-based dynamic role selection logic 170. Thus, in some embodiments, the selection of the “primary” role can be performed proactively based on predictions generated by the AI-based dynamic role selection logic 170 and/or reactively (e.g., when a current primary one of the distributed system monitors 106 goes down).

At least portions of the functionality of the role adjustment logic 160 and the AI-based dynamic role selection logic 170 may be implemented at least in part in the form of software that is stored in memory and executed by a processor.

The host devices 101, the data centers 102 and the monitoring role controller 107 in the FIG. 1 embodiment are assumed to be implemented using at least one processing platform, with each processing platform comprising one or more processing devices each having a processor coupled to a memory. Such processing devices can illustratively include particular arrangements of compute, storage and network resources. For example, processing devices in some embodiments are implemented at least in part utilizing virtual resources such as VMs or Linux containers (LXCs), or combinations of both as in an arrangement in which Docker containers or other types of LXCs are configured to run on VMs.

The host devices 101, the data centers 102 and the monitoring role controller 107 (or one or more components thereof such as the distributed system nodes 104, the distributed system monitors 106, the role adjustment logic 160, the AI-based dynamic role selection logic 170) may be implemented on respective distinct processing platforms, although numerous other arrangements are possible. For example, in some embodiments at least portions of one or more of the host devices 101 and one or more of the data centers 102 are implemented on the same processing platform. Further, the monitoring role controller 107 can be implemented at least in part within at least one processing platform that implements at least a subset of the host devices 101 and/or the data centers 102.

The network 105 may be implemented using multiple networks of different types. For example, the network 105 may comprise a portion of a global computer network such as the Internet, although other types of networks can be part of the network 105 including a wide area network (WAN), a local area network (LAN), a satellite network, a telephone or cable network, a cellular network, a wireless network such as a WiFi or WiMAX network, a storage area network (SAN), or various portions or combinations of these and other types of networks. The network 105 in some embodiments therefore comprises combinations of multiple different types of networks each comprising processing devices configured to communicate using Internet Protocol (IP) or other related communication protocols.

The host devices 101, the data centers 102 and the monitoring role controller 107 in some embodiments may be implemented as part of a cloud-based system. The host devices 101, the data centers 102 and the monitoring role controller 107 can be part of what is more generally referred to herein as a processing platform comprising one or more processing devices each comprising a processor coupled to a memory. A given such processing device may correspond to one or more virtual machines or other types of virtualization infrastructure such as Docker containers or other types of LXCs. As indicated above, communications between such elements of system 100 may take place over one or more networks including network 105.

The term “processing platform” as used herein is intended to be broadly construed so as to encompass, by way of illustration and without limitation, multiple sets of processing devices and one or more associated storage systems that are configured to communicate over one or more networks. For example, distributed implementations of the host devices 101, the data centers 102 and the monitoring role controller 107 are possible, in which certain ones of the host devices 101 and the data centers 102 reside in a first geographic location while other ones of the host devices 101 and/or the data centers 102 reside in at least a second geographic location that is potentially remote from the first geographic location. The monitoring role controller 107 may be implemented at least in part in the first geographic location, the second geographic location, and one or more other geographic locations. Thus, it is possible in some implementations of the system 100 for different ones of the host devices 101, the data centers 102 and the monitoring role controller 107 to reside in different geographic locations. Numerous other distributed implementations of the host devices 101, the data centers 102 and the monitoring role controller 107 are possible.

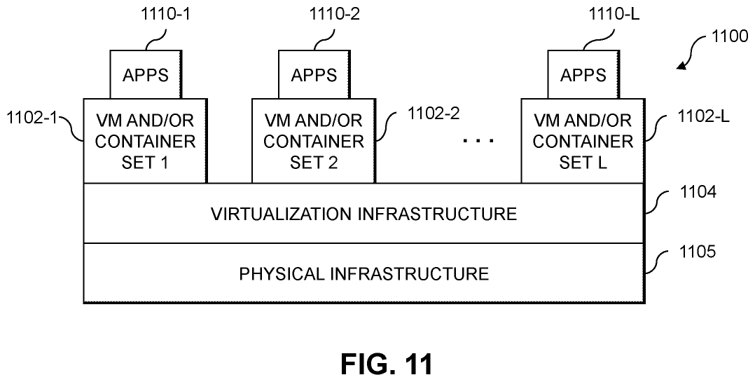

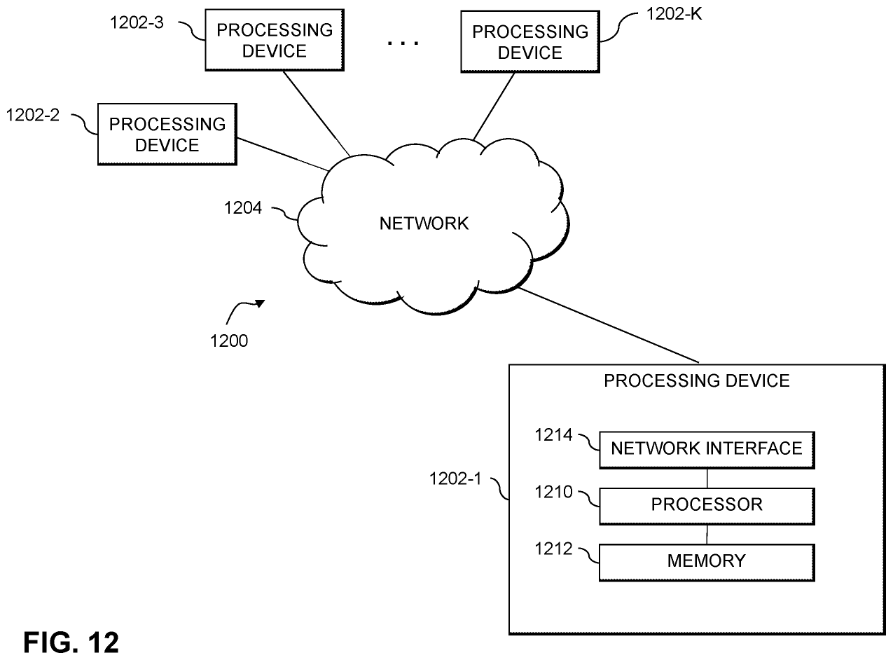

Additional examples of processing platforms utilized to implement portions of the system 100 in illustrative embodiments will be described in more detail below in conjunction with FIGS. 11 and 12.

It is to be understood that the particular set of elements shown in FIG. 1 for controlling monitoring roles of monitoring nodes (e.g., distributed system monitors 106) in a monitoring system is presented by way of illustrative example only, and in other embodiments additional or alternative elements may be used. Thus, another embodiment may include additional or alternative systems, devices, and other network entities, as well as different arrangements of modules and other components.

It is to be appreciated that these and other features of illustrative embodiments are presented by way of example only, and should not be construed as limiting in any way.

Various modern databases support a distributed architecture with high availability, and such databases come with or utilize a database monitoring system. The database monitoring system may comprise a primary monitoring module (also referred to herein as a primary monitor) and a secondary or backup monitoring module (also referred to herein as a secondary or backup monitor). The primary monitor will monitor the primary database of a distributed database system and send “heartbeat” messages to the backup monitor (e.g., at regular intervals).

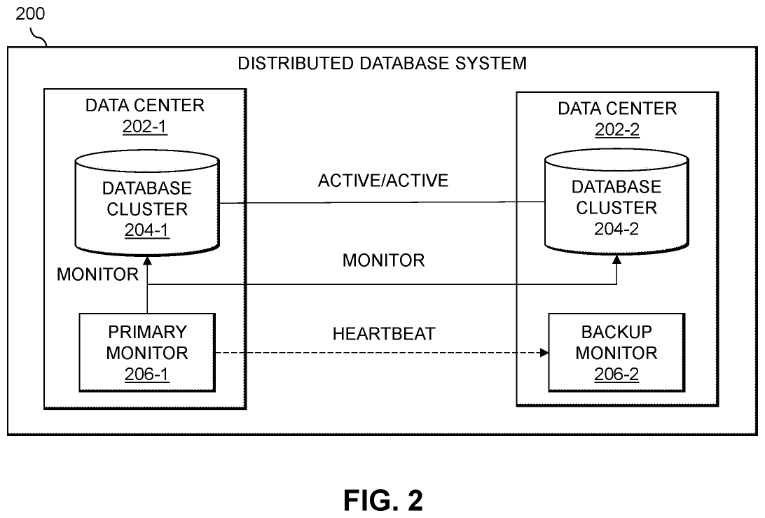

FIG. 2 illustrates such a distributed database system monitoring architecture, where there are two data centers 202-1 and 202-2 (collectively, data centers 202) that implement respective database clusters 204-1 and 204-2 (collectively, database clusters 204) of a distributed database system 200. In the FIG. 2 example, the data center 202-1 implements the primary monitor 206-1 and the data center 202-2 implements the backup monitor 206-2. The primary monitor 206-1 monitors the database clusters 204 of the distributed database system 200, and periodically sends heartbeat messages to the backup monitor 206-2.

In the case of failure of the data center 202-1, the distributed database system 200 is not impacted due to its active-active configuration. The distributed database system 200 can perform a failover process based on the implementation (e.g., a quorum algorithm). In the FIG. 2 example, the primary monitor 206-1 (implemented within the data center 202-1) will go down when the data center 202-1 fails, for example, such that no heartbeat message will be sent to the backup monitor 206-2 at its regular interval. When the backup monitor 206-2 does not receive a heartbeat message at the regular interval (e.g., in 60 seconds or some other configurable time interval), the backup monitor 206-2 will assume the primary role. Further details related to such scenarios are described in, for example, U.S. application Ser. No. 17/573,141, filed on Jan. 11, 2022, which is hereby incorporated by reference in its entirety.

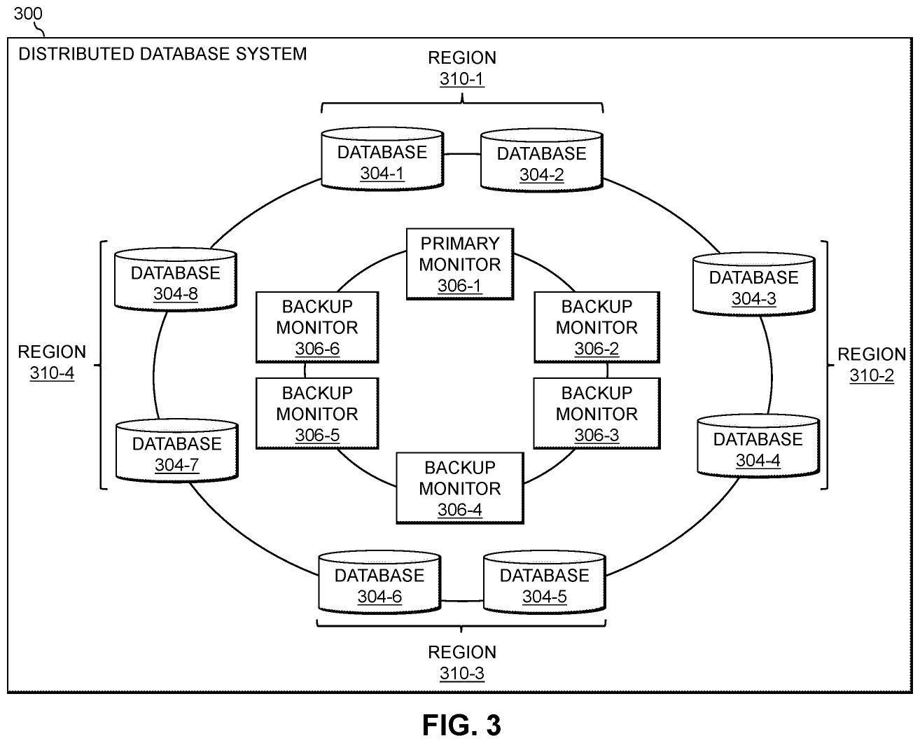

FIG. 3 shows a monitoring system for a distributed database system 300 in an illustrative embodiment. In this example, the distributed database system 300 includes a set of databases 304-1 through 304-8 (collectively, databases 304) and database monitors 306-1 through 306-6 (collectively, database monitors 306) distributed across a set of regions 310-1 through 310-4 (collectively, regions 310). In the FIG. 3 example, the databases 304-1 and 304-2 as well as primary monitor 306-1 are in region 310-1 (e.g., a Western United States region), the databases 304-3 and 304-4 as well as backup monitors 306-2 and 306-3 are in region 310-2 (e.g., an Eastern United States region), the databases 304-5 and 304-6 as well as backup monitor 306-4 are in region 310-3 (e.g., a Europe, the Middle East and Africa (EMEA) region), and the databases 304-7 and 304-8 as well as backup monitors 306-5 and 306-6 are in region 310-4 (e.g., an Asia-Pacific region) It should again be noted that that the monitoring system for a distributed database system does not necessarily include the same number of database instances and database monitors (e.g., there may be fewer monitors than database instances, or more monitors than database instances). As illustrated in the FIG. 3, for example, there are four database nodes or instances 304-1 through 304-4 in regions 310-1 and 310-2, but only three monitors 306-1, 306-2 and 306-3 altogether in the regions 310-1 and 310-2. Similarly, there are two database nodes or instances 304-5 and 304-6 in region 310-3, but only one backup monitor 306-4 in the region 310-3.

In the FIG. 3 scenario, the primary monitor 306-1 will perform monitoring for all databases 304, and the backup monitors 306-2 through 306-6 will act as backups. If the primary monitor 306-1 goes down, however, it is difficult to determine which of the backup monitors should take on the primary role The transactional load in the distributed database system may vary across the databases 304 over time. For example, in the morning time in region 310-1 (e.g., Western United States), a higher amount of transactions may be generated in database instances 304-1 and 304-2, while in the morning time of region 310-3 (e.g., EMEA) a higher amount of transactions may be generated in database instances 304-5 and 304-6, and so on If the primary monitor 306-1 always remains in the region 310-1, the latency of the majority of transactions in the distributed database system may be significantly higher at some times (e.g., the peak times for regions 310-2 through 310-4). Further, there may be seasonality in the transactional load. For example, database instances 304-1 through 304-4 in the regions 310-1 and 310-2 (e.g., Western and Eastern United States) may be higher during “Black Friday” shopping times. Thus, always keeping the primary monitor 306-I in the same region 310-1 is not the most efficient way to implement the monitoring system for a distributed database system.

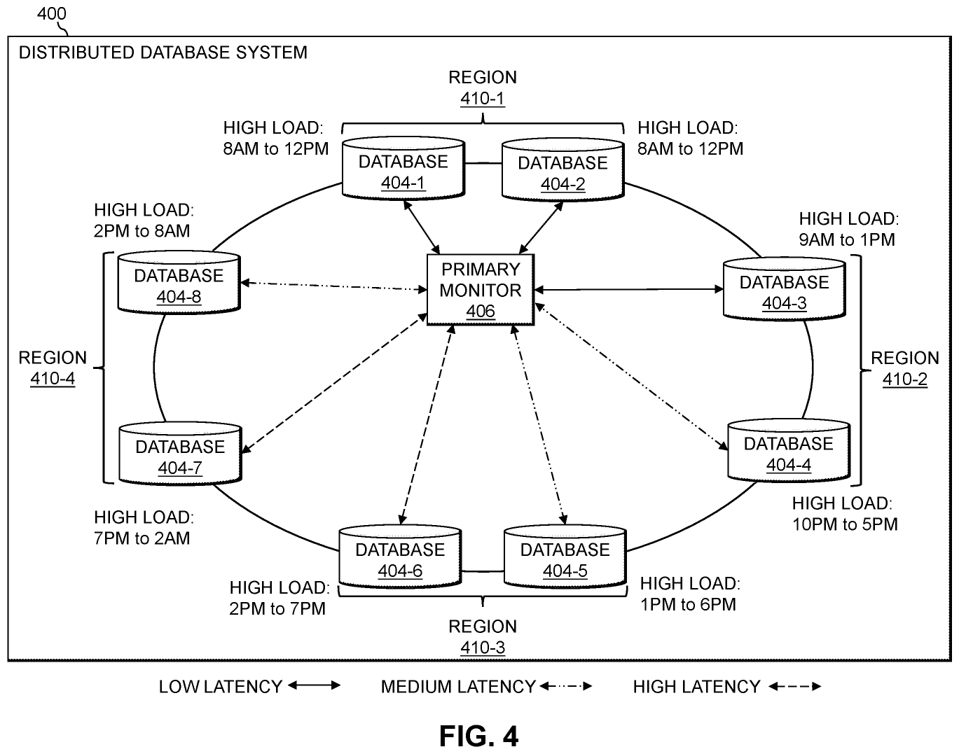

FIG. 4 shows latency between a primary monitor and multiple database nodes of a distributed database system 400 in different regions having different transactional load peak times in an illustrative embodiment. Specifically, the example in FIG. 4 shows a simplified “N” node distributed architecture with database instances 404-1 through 404-8 separated across regions 410-1 through 410-4 in a manner similar to that described above with respect to databases 304 and regions 310 shown in FIG. 3. For clarity of illustration, FIG. 4 shows only a single current primary monitor 406. As shown in FIG. 4, the database instances 404 experience high load at different times of the day. For example, high loads can be experienced between 8 AM-12 PM for databases 404-1 and 404-2, between 9 AM-1 PM for database 404-3, between 10 PM-5 PM for database 404-4, between 1 PM-6 PM for database 404-5, between 2 PM-7 PM for database 404-6, between 7 PM-2 AM for database 404-7, and between 2 PM-8 AM for database 404-8, where the times are specified for a particular region (e.g., region 410-1).

FIG. 4 also illustrates connections between the database instances 404 and primary monitor 406 with different line dashing formats corresponding to low, medium, and high latency network connections. As can be seen from FIG. 4, between 2 PM and 2 AM, the region 410-3 will have the highest transaction load but the worst latency with the primary monitor 406 (assumed to be in region 410-1). Thus, if the primary monitor remains in region 1 during this time, then the performance of the system can be negatively impacted. Some distributed database monitoring systems can be configured with multiple backup monitors, and such systems generally promote one of the backup monitors to a primary role in response to the primary monitor becoming unavailable. However, such systems do not proactively change the primary monitor based on varying traffic loads across different regions when monitoring transactions.

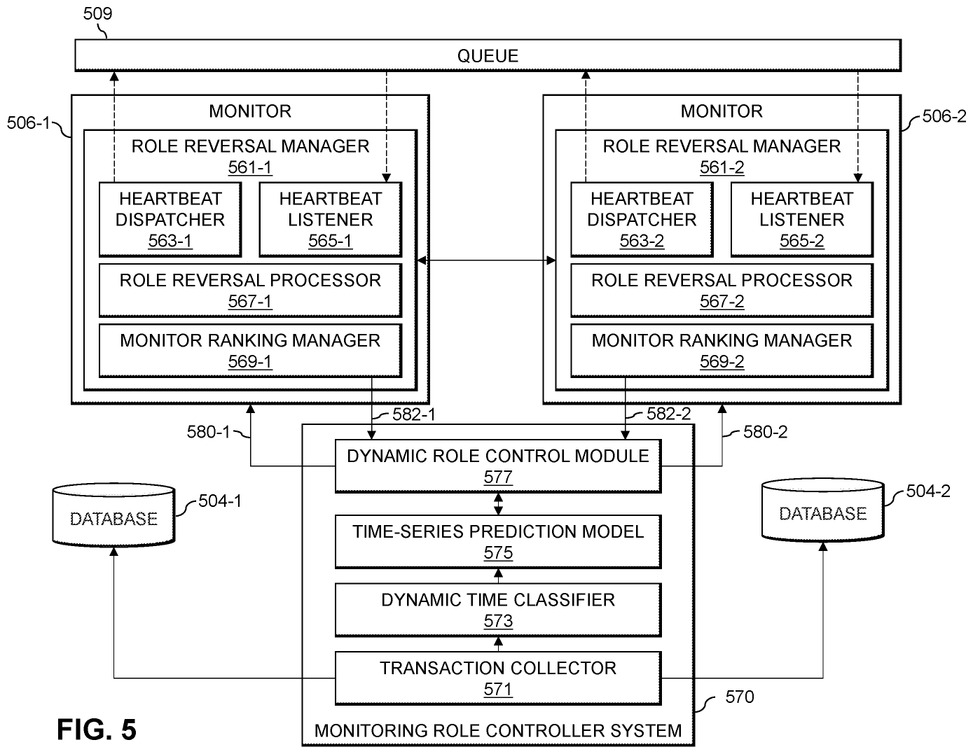

FIG. 5 shows an implementation of topology-aware monitoring role selection of a monitoring system in an illustrative embodiment. In this example, only two database instances 504-1 and 504-2 (collectively, databases 504) of a distributed database system and only two monitors 506-1 and 506-2 (collectively, monitors 506) are shown for clarity of illustration. It should be appreciated, however, that there may be more than two database instances and/or more than two monitors. Further, as discussed above, there is not necessarily a one-to-one correspondence between database instances and monitors-there may be more or fewer monitors than database instances. It is also assumed that the databases 504 are located across multiple geographical regions.

Here, a monitoring role controller system 570 (e.g., corresponding to the monitoring role controller 107 in FIG. 1) implements a transaction collector 571, which collects transactions from the databases 504. The transaction collector 571 is coupled to a dynamic time classifier 573 (e.g., a k-nearest neighbors (KNN) dynamic time classifier) that classifies (or clusters) the databases 504 based on variations in transactional load as determined from the collected transactions. A time-series prediction model 575 of the monitoring role controller system 570 obtains the output of the dynamic time classifier 573 and predicts a primary monitor (e.g., an optimal primary monitor) for a given time interval. For example, the time-series prediction model 575 can be trained to learn the time-based differences in transaction loads of the databases 504 across different regions. In some embodiments, the time-series prediction model 575 can also be trained on data related to the availability of the databases 504. A dynamic role control module 577 of the monitoring role controller system 570 polls the time-series prediction model 575 to obtain the predicted primary monitor for a particular time interval.

The monitors 506-1 and 506-2 implement respective role reversal managers 561-1 and 561-2 (collectively, role reversal managers 561). The role reversal managers 561-1 and 561-2 implement respective heartbeat dispatchers 563-1 and 563-2 (collectively, heartbeat dispatchers 563), heartbeat listeners 565-1 and 565-2 (collectively, heartbeat listeners 565), role reversal processors 567-1 and 567-2 (collectively, role reversal processors 567), and monitor ranking managers 569-1 and 569-2 (collectively, monitor ranking managers 569).

The heartbeat dispatchers 563 are configured to send heartbeat messages to a queue 509, while the heartbeat listeners 565 are configured to receive heartbeat messages from the queue 509. At any given time, one of the monitors (e.g., monitor 506-1) will be acting as the primary, and thus it will use its heartbeat dispatcher 563-1 to issue or send heartbeat messages to the queue 509, while other monitors (e.g., monitor 506-2) will be acting as backups and will use its heartbeat listener 565-2 to listen for heartbeat messages on the queue 509 at a set interval (e.g., which may be based on the ranking of that monitor 506-2 as described in further detail elsewhere herein).

The role reversal processors 567 are configured to switch the roles of the monitors 506 (e.g., from primary to backup and vice-versa) in response to determining that the current primary monitor is unavailable. In this situation, the determination of the new primary monitor can be based on a ranking of the monitors 506 with respect to latency across the databases 504.

Also, in some embodiments, the role reversal processors 567 can switch the roles of the monitors 506 based on messages output by the dynamic role control module 577 to the role reversal managers 561. For example, if the time-series prediction model 575 determines that monitor 506-2 should be used as the primary monitor for a particular time interval, then the dynamic role control module 577 can send a message 580-1 to the current primary monitor 506-1 and a message 580-2 to the backup monitor 506-2 to trigger the change. In response to the message 580-1, the role reversal processor 567-1 changes the role of the monitor 506-1 from a primary role to a backup role for the given time interval. The role reversal manager 561-1 then sends a message 582-1 to the dynamic role control module 577 acknowledging the change. Similarly, in response to the message 580-2, the role reversal processor 567-2 changes the role of the monitor 506-2 from a backup role to a primary role for the given time interval. The role reversal manager 561-2 then sends a message 582-2 to the dynamic role control module 577 acknowledging the change.

In response to receiving the messages 582-1 and 582-2, the dynamic role control module 577 can shift the primary role without delay between different monitors, for example, throughout a given day.

Generally, the monitor ranking managers 569 are configured to keep a latest snapshot of the time-based ranking of monitors 506, which provide information to the role reversal processors 567 indicating a ranking of the monitors to which the primary role should be shifted in the event of failover.

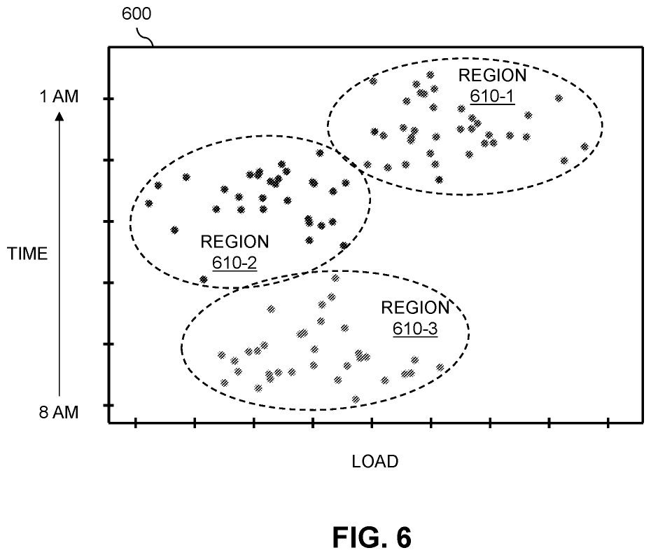

FIG. 6 shows an example of a plot 600 illustrating a clustering of load in different regions at different times in an illustrative embodiment. The plot can be generated based at least in part on the output of the dynamic time classifier 573. The plot 600 shows load as a function of time with clusters for regions 610-1 (e.g., United States), 610-2 (Asia-Pacific) and 610-3 (e.g., EMEA). The load can then be classified based on time, as well as potentially other factors such as transaction criticality. Those skilled in the art will appreciate that various time series machine learning classification algorithms may be used. In some embodiments, a KNN algorithm with dynamic time wrapping is utilized, resulting in the plot 600 of FIG. 6.

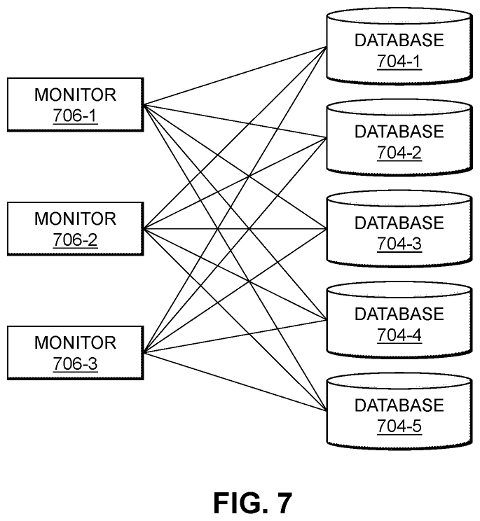

According to some embodiments, the latency of each monitor to the different database instances may also be logged. Consider the example of FIG. 7, where there are three monitors 706-1, 706-2 and 706-3 (collectively, monitors 706) and five database nodes 704-1, 704-2, 704-3, 704-4 and 704-5 (collectively, database nodes 704). The latency between each of the monitors 706 and each of the database nodes 704 may be logged. With the results of the classification, latency metrics, and possibly the historical information related to the availability, the time-series prediction model 575 can select a primary monitor to be used for one or more periods of time.

As an example, the time-series prediction model 575 may be implemented using one or more time-series prediction and/or forecasting processes, including regression-based models and/or autoregression-based models (e.g., a seasonal autoregressive integrated moving-average model (SARIMA) and a Prophet model). Generally, autoregression-based models explain a future variable using its past (or lagged) values. By way of example, the time-series prediction model 575 can obtain output (e.g., the regions 610) generated by the dynamic time classifier 573, and then process data corresponding to one or more parameters associated with each respective region as part of a continuous learning process. For example, the one or more parameters may correspond to one or more of: region-specific load, hardware resources (including processing and/or memory resources), software resources, a number of requests, a number and/or types of alerts triggered in particular region, and/or other performance-related metrics.

Accordingly, the time-series prediction model 575 can predict a primary monitor for a given time interval based on the data across all of the regions.

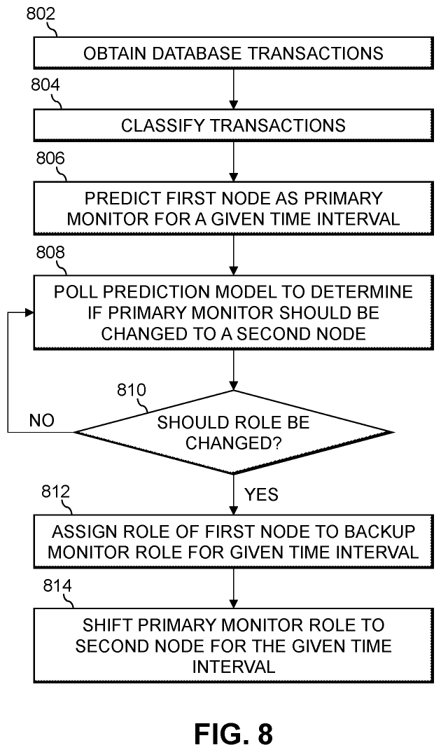

FIG. 8 shows an overall process flow for dynamically controlling monitoring roles in an illustrative embodiment. In some embodiments, the process may be implemented at least in part in the monitoring system shown in FIG. 5, for example. It is to be understood that this particular process is only an example, and additional or alternative processes can be carried out in other embodiments. In this embodiment, the process includes steps 802 through 814.

Step 802 includes obtaining database transactions. For example, the transactions can be obtained by the transaction collector 571 from the databases 504 located across different regions. Step 804 includes classifying the transactions. For example, step 804 can be performed by the dynamic time classifier 573 to classify the load across the different regions. Step 806 includes predicting a first node as a primary monitor for a given time interval. For example, the prediction can be generated by a prediction model (e.g., time-series prediction model 575 model). Step 808 includes polling the prediction model to determine if the primary monitor should be changed to a second node (e.g., in a different region). For example, step 808 can be performed periodically to consider new database transactions that are collected. Step 810 includes a test that determines whether the role should be changed based on one or more results of step 808. If no, then the process returns to step 808. Otherwise, the process continues to step 812. Step 812 includes assigning the role of the first node to backup monitor role for the given time interval. Step 814 includes shifting the primary monitor role to second node for the given time interval.

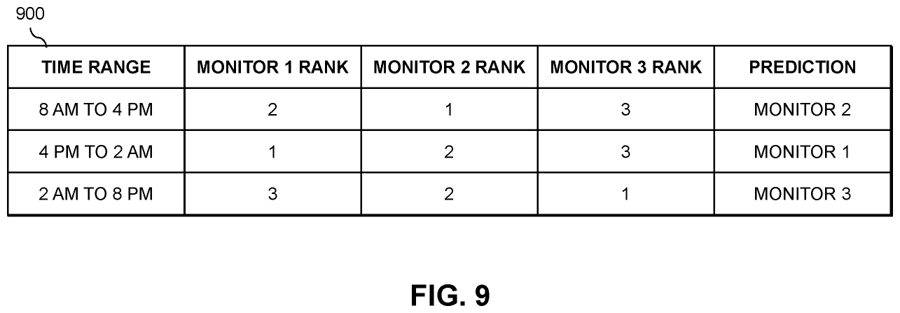

It is to be appreciated that the process depicted in FIG. 8 can be performed for different time intervals (e.g., within a given day, week, etc.). By way of example, FIG. 9 shows an example of a table 900 showing time-based monitor ranks and predictions in an illustrative embodiment. In this example, there are three monitors, whose rankings change across three different time ranges (specifically, 8 AM to 4 PM, 4 PM to 2 AM, and 2 AM to 8 PM). It should be appreciated that there may be more or fewer than three monitors, and that a particular time-based ranking may have more or fewer than three time ranges (and such time ranges need not be of equal duration). It is noted that the rankings can be performed based on data related to one or more parameters associated with each respective region (e.g., regions 610) and/or one or more data centers thereof.

The table 900 also shows the predicted primary monitor for each interval (e.g., corresponding to the prediction of the time-series prediction model 575). Thus, during the day, the primary monitor role will automatically shift in the following order: monitor 2, monitor 1, monitor 3. It is noted that the primary monitoring role proactively shifts from a first monitor (e.g., monitor 2) to a second monitor (e.g., monitor 1), even when the first monitor is up and running. This is different than conventional approaches, where the primary monitor role is shifted in response to the primary monitoring role becoming unavailable.

It should be noted that the time-based ranking of monitors may be re-calculated at specific intervals, or in response to designated conditions (e.g., addition or removal of monitors from a monitoring system, addition or removal of databases from a distributed database system, etc.).

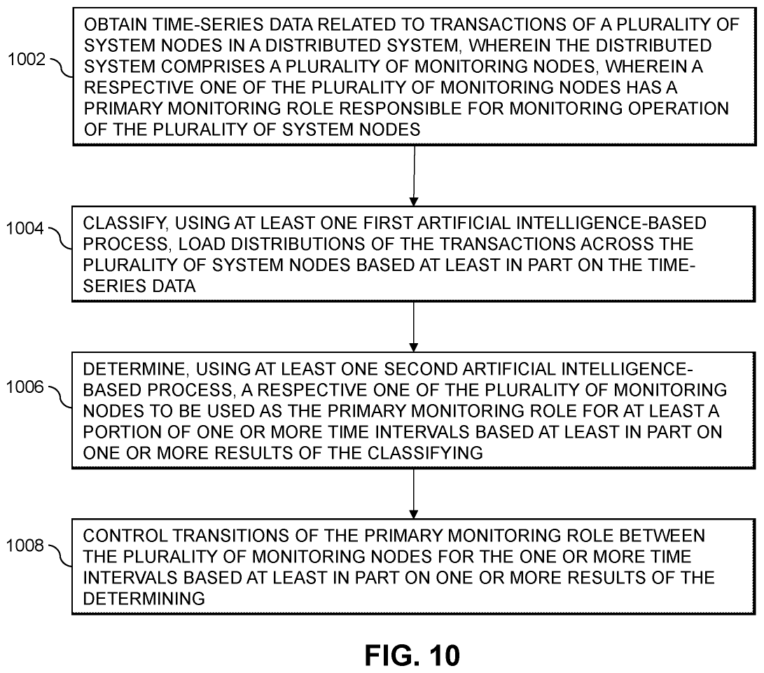

FIG. 10 is a flow diagram of a process for controlling monitoring roles of nodes using AI techniques in an illustrative embodiment. It is to be understood that this particular process is only an example, and additional or alternative processes can be carried out in other embodiments.

In this embodiment, the process includes steps 1002 through 1008. These steps are assumed to be performed by the monitoring role controller 107 using its AI-based dynamic role selection logic 170.

Step 1002 includes obtaining time-series data related to transactions of a plurality of system nodes in a distributed system, wherein the distributed system comprises a plurality of monitoring nodes, wherein a respective one of the plurality of monitoring nodes has a primary monitoring role responsible for monitoring operation of the plurality of system nodes. Step 1004 includes classifying, using at least one first artificial intelligence-based process, load distributions of the transactions across the plurality of system nodes based at least in part on the time-series data. Step 1006 includes determining, using at least one second artificial intelligence-based process, a respective one of the plurality of monitoring nodes to be used as the primary monitoring role for at least a portion of one or more time intervals based at least in part on one or more results of the classifying. Step 1008 includes controlling transitions of the primary monitoring role between the plurality of monitoring nodes for the one or more time intervals based at least in part on one or more results of the determining.

At least a first one of the plurality of monitoring nodes may be in a first geographic location and at least a second one of the plurality of monitoring nodes is in a different, second geographic location. The determining may be further based on data indicating at least one of: availability of at least a portion of the plurality of monitoring nodes; a level of criticality of at least a portion of the transactions; and latency between respective ones of the plurality of monitoring nodes and respective ones of the plurality of system nodes. The at least one first AI-based process may include a k-nearest neighbor dynamic time-based classifier. The at least one second AI-based process comprises a time-series prediction model. The one or more time intervals may correspond to time intervals of a particular day. Controlling a given one of the transitions include: transmitting a first message to a first one of the plurality of monitoring nodes that was previously assigned the primary monitoring role for a given time interval of the one or more time intervals; transmitting a second message to a second one of the plurality of monitoring nodes that is to be used as the primary monitoring role for the given time interval of the one or more time intervals; receiving acknowledgment messages from the first monitoring node and the second monitoring node; and controlling the transition of the primary monitoring role to the second monitoring node for the given time interval of the one or more time intervals based at least in part on the acknowledgment messages. The distributed system may include a distributed database system, and wherein the plurality of system nodes of the distributed system may include a plurality of database nodes in the distributed database system.

Accordingly, the particular processing operations and other functionality described in conjunction with the flow diagram of FIG. 10 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to significantly improve the performance of distributed database monitoring systems by determining nodes across different regions to be implemented as a primary monitoring role using AI-based techniques, and then proactively shifting the roles between the nodes to increase the monitoring performance. These and other embodiments can effectively overcome problems associated with existing testing techniques that generally require shift monitoring roles reactively (e.g., in response to a primary monitor node becoming unavailable).

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms will now be described in greater detail with reference to FIGS. 11 and 12. Although described in the context of system 100, these platforms may also be used to implement at least portions of other information processing systems in other embodiments.

FIG. 11 shows an example processing platform comprising cloud infrastructure 1100. The cloud infrastructure 1100 comprises a combination of physical and virtual processing resources that are utilized to implement at least a portion of the information processing system 100. The cloud infrastructure 1100 comprises multiple VMs and/or container sets 1102-1, 1102-2, . . . 1102-L implemented using virtualization infrastructure 1104. The virtualization infrastructure 1104 runs on physical infrastructure 1105, and illustratively comprises one or more hypervisors and/or operating system level virtualization infrastructure. The operating system level virtualization infrastructure illustratively comprises kernel control groups of a Linux operating system or other type of operating system.

The cloud infrastructure 1100 further comprises sets of applications 1110-1, 1110-2, . . . 1110-L running on respective ones of the VMs/container sets 1102-1, 1102-2, . . . 1102-L under the control of the virtualization infrastructure 1104. The VMs/container sets 1102 comprise respective VMs, respective sets of one or more containers, or respective sets of one or more containers running in VMs.

In some implementations of the FIG. 11 embodiment, the VMs/container sets 1102 comprise respective VMs implemented using virtualization infrastructure 1104 that comprises at least one hypervisor. A hypervisor platform may be used to implement a hypervisor within the virtualization infrastructure 1104, wherein the hypervisor platform has an associated virtual infrastructure management system. The underlying physical machines comprise one or more distributed processing platforms that include one or more storage systems.

In other implementations of the FIG. 11 embodiment, the VMs/container sets 1102 comprise respective containers implemented using virtualization infrastructure 1104 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1100 shown in FIG. 11 may represent at least a portion of one processing platform. Another example of such a processing platform is processing platform 1200 shown in FIG. 12.

The processing platform 1200 in this embodiment comprises a portion of system 100 and includes a plurality of processing devices, denoted 1202-1, 1202-2, 1202-3, . . . 1202-K, which communicate with one another over a network 1204.

The network 1204 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1202-1 in the processing platform 1200 comprises a processor 1210 coupled to a memory 1212.

The processor 1210 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1212 may comprise random access memory (RAM), read-only memory (ROM), flash memory, or other types of memory, in any combination. The memory 1212 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM, flash memory, or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1202-1 is network interface circuitry 1214, which is used to interface the processing device with the network 1204 and other system components, and may comprise conventional transceivers.

The other processing devices 1202 of the processing platform 1200 are assumed to be configured in a manner similar to that shown for processing device 1202-1 in the figure.

Again, the particular processing platform 1200 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for controlling monitoring roles of monitoring nodes as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, databases, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining time-series data related to transactions of a plurality of system nodes in a distributed system, wherein the distributed system comprises a plurality of monitoring nodes, wherein a respective one of the plurality of monitoring nodes has a primary monitoring role responsible for monitoring operation of the plurality of system nodes;
classifying, using at least one first artificial intelligence-based process, load distributions of the transactions across the plurality of system nodes based at least in part on the time-series data;
determining, using at least one second artificial intelligence-based process, a respective one of the plurality of monitoring nodes to be used as the primary monitoring role for at least a portion of one or more time intervals based at least in part on one or more results of the classifying; and
controlling transitions of the primary monitoring role between the plurality of monitoring nodes for the one or more time intervals based at least in part on one or more results of the determining;
wherein the method is performed by at least one processing device comprising a processor coupled to a memory.

2. The computer-implemented method of claim 1, wherein at least a first one of the plurality of monitoring nodes is in a first geographic location and at least a second one of the plurality of monitoring nodes is in a different, second geographic location.

3. The computer-implemented method of claim 1, wherein the determining is further based on data indicating at least one of:
availability of at least a portion of the plurality of monitoring nodes;
a level of criticality of at least a portion of the transactions; and
latency between respective ones of the plurality of monitoring nodes and respective ones of the plurality of system nodes.

4. The computer-implemented method of claim 1, wherein the at least one first artificial intelligence-based process comprises a k-nearest neighbor dynamic time-based classifier.

5. The computer-implemented method of claim 1, wherein the at least one second artificial intelligence-based process comprises a time-series prediction model.

6. The computer-implemented method of claim 1, wherein the one or more time intervals correspond to time intervals of a particular day.

7. The computer-implemented method of claim 1, wherein controlling a given one of the transitions comprises:
transmitting a first message to a first one of the plurality of monitoring nodes that was previously assigned the primary monitoring role for a given time interval of the one or more time intervals;
transmitting a second message to a second one of the plurality of monitoring nodes that is to be used as the primary monitoring role for the given time interval of the one or more time intervals;
receiving acknowledgment messages from the first monitoring node and the second monitoring node; and
controlling the transition of the primary monitoring role to the second monitoring node for the given time interval of the one or more time intervals based at least in part on the acknowledgment messages.

8. The computer-implemented method of claim 1, wherein the distributed system comprises a distributed database system, and wherein the plurality of system nodes of the distributed system comprises a plurality of database nodes in the distributed database system.

9. A non-transitory processor-readable storage medium having stored therein program code of one or more software programs, wherein the program code when executed by at least one processing device causes the at least one processing device:
to obtain time-series data related to transactions of a plurality of system nodes in a distributed system, wherein the distributed system comprises a plurality of monitoring nodes, wherein a respective one of the plurality of monitoring nodes has a primary monitoring role responsible for monitoring operation of the plurality of system nodes;
to classify, using at least one first artificial intelligence-based process, load distributions of the transactions across the plurality of system nodes based at least in part on the time-series data;
to determine, using at least one second artificial intelligence-based process, a respective one of the plurality of monitoring nodes to be used as the primary monitoring role for at least a portion of one or more time intervals based at least in part on one or more results of the classifying; and
to control transitions of the primary monitoring role between the plurality of monitoring nodes for the one or more time intervals based at least in part on one or more results of the determining.

10. The non-transitory processor-readable storage medium of claim 9, wherein at least a first one of the plurality of monitoring nodes is in a first geographic location and at least a second one of the plurality of monitoring nodes is in a different, second geographic location.

11. The non-transitory processor-readable storage medium of claim 9, wherein the determining is further based on data indicating at least one of:
availability of at least a portion of the plurality of monitoring nodes;
a level of criticality of at least a portion of the transactions; and latency between respective ones of the plurality of monitoring nodes and respective ones of the plurality of system nodes.

12. The non-transitory processor-readable storage medium of claim 9, wherein the at least one first artificial intelligence-based process comprises a k-nearest neighbor dynamic time-based classifier.

13. The non-transitory processor-readable storage medium of claim 9, wherein the at least one second artificial intelligence-based process comprises a time-series prediction model.

14. The non-transitory processor-readable storage medium of claim 9, wherein controlling a given one of the transitions comprises:
transmitting a first message to a first one of the plurality of monitoring nodes that was previously assigned the primary monitoring role for a given time interval of the one or more time intervals;
transmitting a second message to a second one of the plurality of monitoring nodes that is to be used as the primary monitoring role for the given time interval of the one or more time intervals;
receiving acknowledgment messages from the first monitoring node and the second monitoring node; and
controlling the transition of the primary monitoring role to the second monitoring node for the given time interval of the one or more time intervals based at least in part on the acknowledgment messages.

15. An apparatus comprising:
at least one processing device comprising a processor coupled to a memory;
the at least one processing device being configured:
to obtain time-series data related to transactions of a plurality of system nodes in a distributed system, wherein the distributed system comprises a plurality of monitoring nodes, wherein a respective one of the plurality of monitoring nodes has a primary monitoring role responsible for monitoring operation of the plurality of system nodes;
to classify, using at least one first artificial intelligence-based process, load distributions of the transactions across the plurality of system nodes based at least in part on the time-series data;
to determine, using at least one second artificial intelligence-based process, a respective one of the plurality of monitoring nodes to be used as the primary monitoring role for at least a portion of one or more time intervals based at least in part on one or more results of the classifying; and
to control transitions of the primary monitoring role between the plurality of monitoring nodes for the one or more time intervals based at least in part on one or more results of the determining.

16. The apparatus of claim 15, wherein at least a first one of the plurality of monitoring nodes is in a first geographic location and at least a second one of the plurality of monitoring nodes is in a different, second geographic location.

17. The apparatus of claim 15, wherein the determining is further based on data indicating at least one of:
availability of at least a portion of the plurality of monitoring nodes;
a level of criticality of at least a portion of the transactions; and
latency between respective ones of the plurality of monitoring nodes and respective ones of the plurality of system nodes.

18. The apparatus of claim 15, wherein the at least one first artificial intelligence-based process comprises a k-nearest neighbor dynamic time-based classifier.

19. The apparatus of claim 15, wherein the at least one second artificial intelligence-based process comprises a time-series prediction model.

20. The apparatus of claim 15, wherein controlling a given one of the transitions comprises:
transmitting a first message to a first one of the plurality of monitoring nodes that was previously assigned the primary monitoring role for a given time interval of the one or more time intervals;
transmitting a second message to a second one of the plurality of monitoring nodes that is to be used as the primary monitoring role for the given time interval of the one or more time intervals;
receiving acknowledgment messages from the first monitoring node and the second monitoring node; and
controlling the transition of the primary monitoring role to the second monitoring node for the given time interval of the one or more time intervals based at least in part on the acknowledgment messages.
